(19) United States
(12) Patent Application Publication
(10) Pub. No.: US 2013/0091374 A1
(43) Pub. Date: Apr. 11, 2013

(54) MONITORING DEVICE AND METHOD FOR MONITORING POWER PARAMETERS OF MEMORY BANK OF COMPUTING DEVICE

(71) Applicants: PENG CHEN, Shenzhen City (CN); QI-YAN LUO, Shenzhen City (CN); SONG-LIN TONG, Shenzhen City (CN)

(72) Inventors: PENG CHEN, Shenzhen City (CN); QI-YAN LUO, Shenzhen City (CN); SONG-LIN TONG, Shenzhen City (CN)

(21) Appl. No.: 13/626,964

(22) Filed: Sep. 26, 2012

(30) Foreign Application Priority Data
Oct. 6, 2011 (CN) 201110292899.5

(51) Int. Cl. G06F 11/30; G06F 1/26

(52) U.S. Cl. 713/340

(57) ABSTRACT

A monitored device is used to monitor power parameters of a memory bank of a computing device. The monitoring device includes a main circuit board, a connector, and a parameter monitoring device. The parameter monitoring device comprises an acquisition unit, a processing unit, and a display unit. The main circuit board is connected to a power supply and providing power signals to one or more power pins of the memory bank. The connector is connected between the main circuit board and the memory bank. The acquisition unit acquires a voltage passing through each power pin of the memory bank when power is supplied to the memory bank. The processing unit processes the voltage acquired from each of the one or more power pins to obtain power parameters of the memory bank. The display unit displays the power parameters of the memory bank.

### BACKGROUND

1. Technical Field

Embodiments of the present disclosure relate to power parameter monitoring technologies, and particularly to, a monitoring device and method for monitoring power parameters of a memory bank of a computing device.

2. Description of Related Art

Memory banks are widely used in computer systems. Nominal values of power parameters of the memory banks are shown on data sheets of the memory banks to provide reference values for circuit design. However, because these nominal values merely denote values determined from standardized testing, differences may exist between the nominal value and a real value during operation of the memory banks. Therefore, there is a room for improvement in the art.

### BRIEF DESCRIPTION OF THE DRAWINGS

FIG. 1 illustrates a schematic circuit diagram of one embodiment of a monitoring device used for monitoring power parameters of a memory bank.

FIG. 2 illustrates a schematic diagram of a parameter monitoring unit of FIG. 1.

FIG. 3 shows a flowchart of one embodiment of a method for monitoring power parameters of the memory bank of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

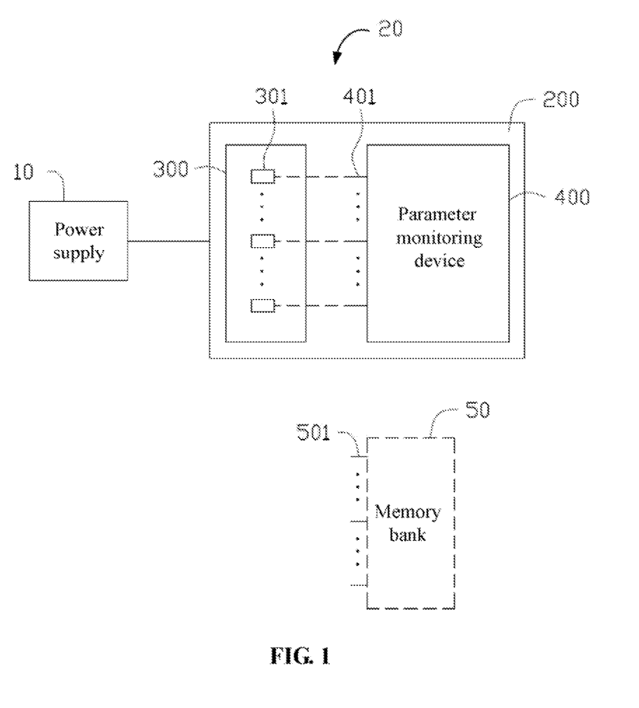

FIG. 1 is a schematic circuit diagram of one embodiment of a monitoring device 20 used for monitoring power parameters of a memory bank 50. The monitoring device 20 includes a main circuit board 200, a connector 300, and a parameter monitoring device 400. The monitoring device 20 is electrically connected to a power supply 10. The power supply 10 supplies power to the monitoring device 20.

The main circuit board 200 may be a motherboard of a computing device including the memory bank 50. The connector 300 is positioned on the main circuit board 200 and electrically connected between the main circuit board 200 and the memory bank 50, to establish an electrical connection between the main circuit board 200 and the memory bank 50. The main circuit board 200 processes power signals output from the power supply 10 according to requirements of the memory bank 50, and provides the processed power signals to one or more power pins 501 (e.g., VTT pin, and VDDQ pin) of the memory bank 50, to power the memory bank 50.

The connector 300 includes a plurality of connection ports 301 respectively corresponding to a plurality of connection pins of the memory bank 50. The connection ports 301 of the connector 300 include one or more power connection ports respectively connected to the one or more power pins 501 of the memory bank 50, to transmit the power signals processed by the main circuit board 200 to the memory bank 50. In one embodiment, the connector 300 may be a slot, and the connection ports of the connector 300 may be embedded in the slot, so that the memory bank 50 can connect to the connector 300 by being inserted into the connector 300. Additionally, the slot may further comprise a plurality of pins respectively corresponding to the connection pins of the memory bank 50. When the memory bank 50 is inserted into the slot, the slot could be inserted into a socket of the memory bank 50 on a motherboard of the computing device, so as to establish connection between the memory bank 50 and the socket.

The parameter monitoring device 400 monitors the power parameters of the memory bank 50 when the memory bank 50 is powered to work. In one embodiment, the parameter monitoring device 400 includes one or more monitoring ports 401 electrically connected to the one or more power pins 501 of the memory bank 50 through the one or more power connection ports of the connector 300.

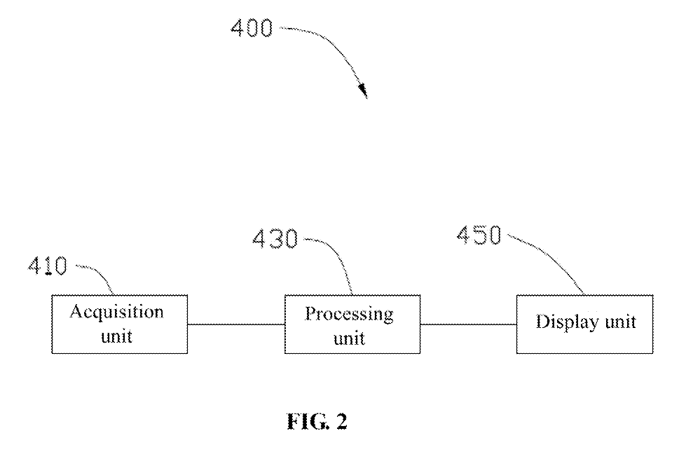

In one embodiment, as shown in FIG. 2, the parameter monitoring device 400 further includes an acquisition unit 410, a processing unit 430, and a display unit 450. The acquisition unit 410 is electrically connected to the one or more monitoring ports 401, and configured for acquiring a voltage passing through each of the one or more power pins 501 of the memory bank 50 in real-time when the memory bank 50 is powered to work. The acquisition unit 410 can be for example a sampling circuit that includes at least a sampling resistor to realize the acquisition of the voltage.

The processing unit 430 processes the voltage acquired from each of the one or more power pins 501 to obtain all power parameters of the memory bank 50. For example, the processing unit 430 may further calculate a current pass through each of the one or more power pins 501, and a total power of the memory bank 50 according to the voltage acquired from each of the one or more power pins 501. Accordingly, the power parameters of the memory bank 50 include the acquired voltage and calculated current passing through each of the one or more power pins 501, and the calculated total power. The display unit 450 is electrically connected to the processing unit 430, and is configured for displaying the power parameters of the memory bank 50. In the embodiment, the display unit 450 may be a liquid crystal display (LCD).

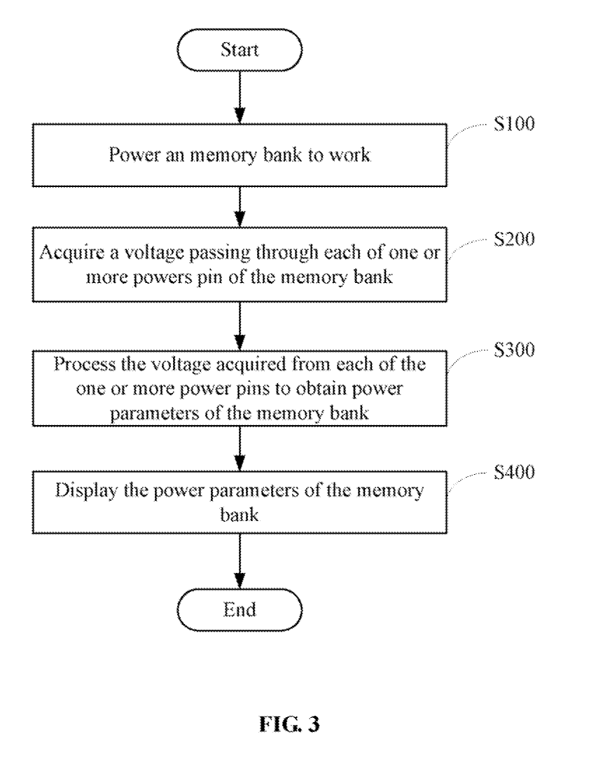

FIG. 3 is a flowchart of one embodiment of a method for monitoring power parameters of the memory bank 50 using the monitoring device 20 of FIG. 1. Depending on the embodiment, additional steps may be added, others removed, and the ordering of the steps may be changed.

In step S100, the memory bank 50 is powered to work. In one embodiment, the main circuit board 200 processes power signals output from the power supply 10 and powers the memory bank 50 to work using the processed signals.

In step S200, the acquisition unit 410 acquires a voltage passing through each of the one or more power pins 501 of the memory bank 50.

In step S300, the processing unit 430 processes the voltage acquired from each of the one or more power pins 501 to obtain all power parameters of the memory bank 50. For example, the processing unit 430 may further calculate a current passing through each of the one or more power pins 501 and a total power of the memory bank 50 according to the voltage acquired from each of the one or more power pins 501. Accordingly, the power parameters of the memory bank 50 include the acquired voltage and calculated current passing through each of the one or more power pins 501, and the calculated total power of the memory bank 50.

In step S400, the display unit 430 displays the power parameters of the memory bank 50.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A monitoring device for monitoring power parameters of a memory bank of a computing device, comprising:
a main circuit board electrically connected to a power supply, and configured for processing power signals outputted from the power supply and providing the processed power signals to one or more power pins of the memory bank to power the memory bank to work;
a connector electrically connected between the main circuit board and the memory bank; and
a parameter monitoring device electrically connected to the memory bank through the connector, comprising:
an acquisition unit configured for acquiring a voltage passing through each of the power pins of the memory bank when power is applied to the memory bank;
a processing unit electrically connected to the acquisition unit, and configured for processing the voltage acquired from each of the one or more power pins to obtain all power parameters of the memory bank; and
a display unit electrically connected to the processing unit, and configured for displaying the power parameters of the memory bank.

2. The monitoring device according to claim 1, wherein the connector comprises a plurality of connection ports respectively connected to a plurality of connection pins of the memory bank, and the connection ports comprise one or more power connection ports electrically connected to the one or more power pins of the memory bank.

3. The monitoring device according to claim 2, wherein the parameter monitoring device further comprises one or more monitoring ports respectively and electrically connected to the one or more power pins through the one or more power connection ports.

4. The monitoring device according to claim 1, wherein the connector is a slot, the connection ports of the connector are embedded in the slot, and the memory bank is connected to the connector by being inserted into the connector.

5. The monitoring device according to claim 1, wherein the processing unit further calculates a current passing through each of the one or more power pins and a total power of the memory bank according to the voltage acquired from each of the one or more power pins.

6. The monitoring device according to claim 5, wherein the power parameters of the memory bank comprise the acquired voltage and calculated current passing through each of the one or more power pins, and the calculated total power of the memory bank.

7. The monitoring device according to claim 1, wherein the acquisition unit is a sampling circuit that comprises at least a sampling resistor to realize the acquisition of the voltage.

8. The monitoring device according to claim 1, wherein the main circuit board is a motherboard of the computing device.

9. A method for monitoring power parameters of a memory bank of a computing device, comprising:
providing a monitoring device, the monitoring device comprising a main circuit board, a connector, and a parameter monitoring device that comprises an acquisition unit, a processing unit, and a display unit, wherein the main circuit board is electrically connected to a power supply and providing power signals to one or more power pins of the memory bank to power the memory bank to work, the connector is electrically connected between the main circuit board and the memory bank, and the parameter monitoring device is electrically connected to the memory bank through the connector;
acquiring a voltage passing through each of the one or more power pins of the memory bank using the acquisition unit when power is supplied to the memory bank;
processing the voltage acquired from each of the one or more power pins to obtain all power parameters of the memory bank using the processing unit; and
displaying the power parameters of the memory bank using the display unit.

10. The method according to claim 9, wherein the connector comprises a plurality of connection ports respectively connected to a plurality of connection pins of the memory bank, and the connection ports comprise one or more power connection ports respectively and electrically connected to the one or more power pins of the memory bank.

11. The method according to claim 10, wherein the parameter monitoring device further comprises one or more monitoring ports respectively and electrically connected to the one or more power pins through the one or more power connection ports.

12. The method according to claim 9, wherein the connector is a slot, the connection ports of the connector are embedded in the slot, and the memory bank connects to the connector by being inserted into the connector.

13. The method according to claim 9, wherein the processing unit further calculates a current passing through each of the one or more power pins and a total power of the memory bank according to the voltage acquired from each of the one or more power pins.

14. The method according to claim 13, wherein the power parameters of the memory bank comprise the acquired voltage and calculated current passing through each of the one or more power pins, and the calculated total power of the memory bank.

15. The method according to claim 9, wherein the acquisition unit is a sampling circuit that comprises at least a sampling resistor to realize the acquisition of the voltage.

16. The method according to claim 9, wherein the main circuit board is a motherboard of the computing device.
